(19) United States
(12) Patent Application Publication
(10) Pub. No.: US 2004/0188388 A1
(43) Pub. Date: Sep. 30, 2004

(54) Low-voltage circuit breaker with an electric arc extinction system

(76) Inventors: Michael Bach, Berlin (DE); Detlev Schmidt, Berlin (DE); Michael Sebekow, Berlin (DE); Gunter Seidler, Berlin (DE); Ingo Thiede, Berlin (DE); Sezai Turkmen, Berlin (DE)

Correspondence Address: HARNESS, DICKEY & PIERCE, P.L.C., P.O.BOX 8910, RESTON, VA, 20195, US

(21) Appl. No.: 10/469,875

(22) PCT Filed: Feb. 20, 2002
(86) PCT No.: PCT/DE02/00654

(30) Foreign Application Priority Data
Mar. 6, 2001 (DE) 201 04 325.4

(51) Int. Cl. H01H 9/44

(52) U.S. Cl. 218/37

(57) ABSTRACT

The invention relates to an electric arc extinction chamber system, especially for low-voltage circuit breakers of very high nominal current intensities, wherein parallel electric arc extinction chamber inserts are provided in a housing extending over the entire width of a pole-face arc. The housing of the chamber is sub-divided by a partition wall or several partition walls (15,16,32) which are embodied as components of the housing. The compartments thus formed receive arc splitter cartridges (28,29,30,41,42).

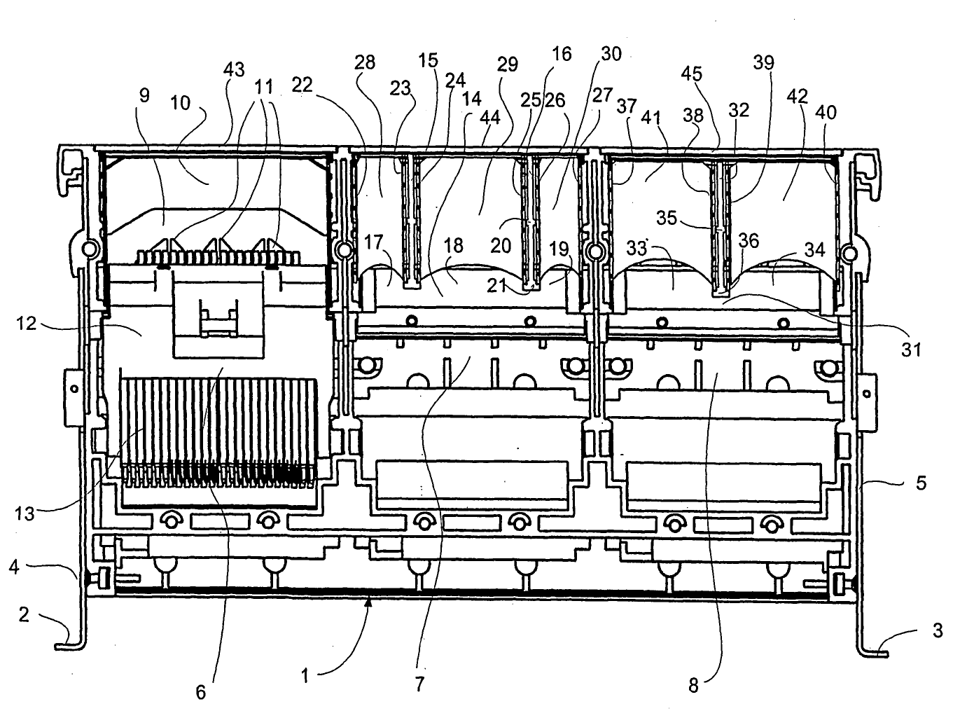

The invention relates to a low-voltage power breaker having an arc-quenching system, in particular for low-voltage power breakers having very high rated current values, in which parallel arc-quenching chamber inserts are provided in a chamber enclosure which extends over the entire width of the poles.

Air-break low-voltage switching devices, such as low-voltage power breakers, require for their operation an arc-quenching device, in the form of arcing chambers for cooling and quenching arcs which occur when the contact is broken, in order to quench any arcs that occur without adversely affecting the power breaker itself and adjacent parts of the system or other assemblies, since, otherwise, there would be a risk of the hot and thus ionized arc gases causing electrical flashovers or resulting in other damage, each arc-quenching chamber generally comprising a large number of arc splitter plates which are arranged between two side walls and contribute to the cooling and quenching of the arc.

Two fundamentally different physical forms of conventional arc-quenching devices are known for low-voltage power breakers. Until now, for large power breakers, complete arcing chambers produced essentially in a conventional manner, separately as a component, i.e. a robust arc-, pressure- and temperature-resistant enclosure containing arc splitter plates and having a suitable blowing apparatus, have been fitted to the power breaker. One arcing chamber is generally provided per pole. This chamber has a complete enclosure whose strength is matched to both the mechanical and the electrical forces of the arc which occurs in it and is to be quenched, in particular with regard to the pressure and the temperature of the switching gases. The arc splitter plates are located in this chamber. The chamber may in this case be in the form of a pot-like shaft into which the plates are inserted, or may be in the form of a structure composed of half-shells, for which an apparatus is required, firstly for inserting the plates into one half-shell, then for fitting the second half-shell, and finally for connecting the two half-shells.

A second physical form makes use of arcing chamber inserts, with which only the function of actual arc quenching can be achieved in one unit. These structures are, however, not capable of withstanding the pressure occurring in connection with the arc. These inserts are therefore inserted in a shaft which is provided in or on the breaker enclosure. Until now, this physical form has predominantly been used for small, compact power breakers, but is increasingly also being used for larger power breakers where the enclosures surround these areas, i.e. the switching area and the quenching area.

With regard to the connection to the main body of the power breaker and the connection of its individual parts to one another, both types have the object of sealing the technically required gaps and joints to prevent the ionized arc gases passing through them, and of preventing electrical flashovers caused by gases which may nevertheless occur.

The arc-quenching chambers can have entirely different dimensions which are dependent on the dimensions of the entire contact system, since the arc-quenching chamber should after all accommodate the arc which runs from the contact system. In this case, low-voltage power breakers having a high rated current have, as a function of the rated or continuous current of the breaker and as a function of the operation, a very wide contact system.

The arc-quenching chamber does not necessarily have to cover the entire width, rather it is sufficient to join the arc by means of a horn and then to pass it into a relatively narrow chamber which is dimensioned such that it has the switching capacity produced by the short-circuit switching capacity of the breaker.

If, however, the contact system is wider than the arc-quenching chamber, this results in a system in which guides are provided to enable the arc to be formed from all of the arc elements which may be struck, and in which the guides guide the arc onto arcing horns which are provided and open into the chamber. This means, however, that these additional guides are necessary, which leads to additional complexity in terms of materials and assembly and to additional expense in connection with this.

It has been proven, however, that it is advantageous and expedient if the chamber is as wide as the contact system and that the arc, irrespective of whether it runs on the left, the right or in the center, runs into the arcing chamber where it can become broader. Extremely wide arc-quenching chambers are, however, deemed unfavorable to a certain extent with regard to the quenching behavior in the case of short-circuit current disconnections. The area available is therefore advantageously filled in a modular fashion using smaller inserts.

Such an arrangement is proposed in DE 197 15 116 C2. In this case, an arcing chamber system having a chamber body is described in which a large number of grooves are arranged on the insides of two opposite side walls, and a number of arcing chamber modules, which each have two opposite side parts, between which a large number of arc splitter plates are, in each case arranged the side parts of the arcing chamber modules being inserted into the corresponding grooves in the side walls.

The grooves provided in the walls of the chamber body reduce the strength of said chamber body, and the base body must have, overall, a greater material strength. This means increased use of materials and an increased weight. A further arc-quenching arrangement is disclosed in DE 17 46 087 U1. A number of isolating profiled bodies are arranged in a retaining frame, which is formed by two flat elements and two U-shaped elements, U-shaped profiled bodies and, in between, double T-shaped profiled bodies in each case being arranged in the edge regions, such that cavities are formed between two adjacent profiled bodies. Grooves are provided on the insides of these cavities for accommodating arc splitter plates. This arrangement can be regarded as an arc-quenching chamber, but no arcing chamber modules are used and neither is there a chamber body since the profiled elements are only held together by a retaining frame.

The object of the invention is thus to provide an arc-quenching device which can be matched in a simple manner to a predetermined switching capacity for a power breaker and which does not have any strength-reducing elements, such as grooves in the enclosure walls.

This object is achieved, in the case of an arc-quenching chamber system, in particular for low-voltage power breakers having very high rated current values, in which parallel arc-quenching chamber inserts are provided in a chamber enclosure which extends over the entire width of the poles, by the fact that, in a complete enclosure, the correspondingly large entire arc-quenching area is divided at suitable intervals over the main current path by one or more partitions. Here, these partitions are advantageously part of the enclosure.

Said partitions are expediently arranged parallel to one another and equidistant from one another. Compartments of equal size are then formed in the entire arc-quenching area. The partitions can, however, also be arranged at different distances from one another such that compartments of differing size are formed.

These different arrangements can be provided, as a function of a different distribution of the contact levers, with or without a primary arcing contact and arcing horn, on the contact support, since the distribution of base points for the arc elements forming should also expediently be configured as a function of the distribution of these contact levers.

An appropriate arc splitter cartridge is inserted in each of these compartments which are formed by said partitions.

These arc splitter cartridges comprise a number of arc splitter plates, which are arranged between two isolating walls arranged parallel to one another, and form autonomous components which can be inserted or withdrawn individually.

In order to support and accommodate the arc splitter cartridges, the partitions have support elements and holders for the isolating walls of the arc splitter cartridges. In order to retain the arc splitter cartridges in the entire arc-quenching area, one arcing chamber cover is provided per switching pole. These arcing chamber covers and arc splitter cartridges are independent of one another and can be inserted and removed individually.

Arc guide horns are provided on the fixed terminal bar of the low-voltage power breaker to match the distribution of the contact levers with or without a primary arcing contact and arcing horns and the distribution of the base points for the arc elements by the arrangement of the arc splitter cartridges. In this case, one arc guide horn is advantageously arranged on the fixed terminal bar for each quenching device element.

The invention will be explained in more detail below for elucidation purposes with reference to a preferred exemplary embodiment which does not limit the scope of the patent.

The single FIGURE shows, in section, an illustration of a three-pole low-voltage power breaker.

The low-voltage power breaker 1 shown in section in the figure shows the breaker feet 2, 3, the side walls 4, 5 and the three switching poles 6, 7, 8. Here, in the present example, the switching poles 6, 7, 8 are illustrated as possible different exemplary embodiments.

The left-hand switching pole 6 in the FIGURE shows a conventional arc splitter arrangement 10, which extends over the entire width of the entire arc-quenching area 9, having arc guide horns 11 located underneath which are distributed uniformly over the width of the switching pole 6, as well as the moveable contact levers 12 on the moveable contact support 13. The upper closure of the entire arc-quenching area 9 is formed by a arcing chamber cover 43 which at the same time performs the function of retaining the arc splitter arrangement 10. A design of this kind for the quenching system is customary for conventional contact lever arrangements in which contact levers without a primary arcing contact are arranged on the outside and contact levers with a primary arcing contact are arranged in the center.

For the central switching pole 7, the entire arc-quenching area 14 is divided by two partitions 15, 16 such that two narrower compartments 17, 19 are formed on the lateral edge regions of the entire arc-quenching area 14, and, in the central region, a wider compartment 18. The partitions 15, 16 are part of the enclosure and have support elements 20 and holders 21 for the isolating walls 22, 23, 24, 25, 26, 27 of the arc splitter cartridges 28, 29, 30. The upper closure of the entire arc-quenching area 14 is formed by a arcing chamber cover 44 which at the same time performs the function of retaining the arc splitter cartridges 28, 29, 30.

For the right-hand switching pole 8, the entire arc-quentching area 31 is divided by a partition 32 into two compartments 33, 34 which are both of equal size. The partition 32 is part of the enclosure in this case too and has support elements 35 and holders 36 for the isolating walls 37, 38, 39, 40 of the arc splitter cartridges 41, 42. The upper closure of the entire arc-quenching area 31 is formed by a arcing chamber cover 45 which at the same time performs the function of retaining the arc splitter cartridges 41, 42.

The major advantage of the solution according to the invention is the fact that the arc splitter cartridges are held in the arcing chamber. The mechanical difference is that, instead of the grooves in the chamber enclosure into which the arc splitter stacks are pushed, partitions are provided for holding the arc splitter stacks in the arcing chamber.

List of Reference Numerals

1 Low-voltage power breaker

2 Breaker foot

3 Breaker foot

4 Side wall

5 Side wall

6 Switching pole

7 Switching pole

8 Switching pole

9 Entire arc-quenching area

10 Arc splitter arrangement

11 Arc guide horn

12 Contact lever

13 Contact support

14 Entire arc-quenching area

15 Partition

16 Partition

17 Compartment

18 Compartment

19 Compartment

20 Support element

21 Holder

22 Isolating wall

23 Isolating wall

24 Isolating wall

25 Isolating wall

26 Isolating wall

27 Isolating wall

28 Arc splitter cartridge

29 Arc splitter cartridge

30 Arc splitter cartridge

31 Entire arc-quenching area

32 Partition

33 Compartment

34 Compartment

35 Support element

36 Holder

37 Isolating wall

38 Isolating wall

39 Isolating wall

40 Isolating wall

41 Arc splitter cartridge

42 Arc splitter cartridge

43 Arcing chamber cover

44 Arcing chamber cover

45 Arcing chamber cover

1. A low-voltage power breaker (1) having an arc-quenching system for low-voltage power breakers having very high rated current values, having parallel arc-quenching chamber inserts arranged in a chamber enclosure which extends over the entire width of the poles,
characterized
in that, in a complete enclosure, the correspondingly large entire arc-quenching area (9, 14; 31) is divided at suitable intervals over the main current path by one or more partitions (15, 16; 32).

2. The low-voltage power breaker as claimed in claim 1,
characterized
in that these partitions (15, 16, 32) are formed as part of the enclosure:

3. The low-voltage power breaker as claimed in claim 1 or 2,
characterized
in that the partitions (15, 16; 32) are arranged parallel to one another and equidistant from one another.

4. The low-voltage power breaker as claimed in one of the preceding claims,
characterized
in that the partitions (15, 16; 32) are arranged at different distances from one another.

5. The low-voltage power breaker as claimed in one of the preceding claims,
characterized
in that an appropriate arc splitter cartridge (28, 29, 30; 41, 42) is inserted in each of these compartments (17, 18, 19; 33, 34) which are formed by said partitions (15, 16; 32).

6. The low-voltage power breaker as claimed in claim 5,
characterized
in that each arc splitter cartridge (28, 29, 30; 41, 42) comprises a number of arc splitter plates which are arranged between two isolating walls (22, 23, 24, 25, 26, 27) which are arranged parallel to one another, and in that said arc splitter cartridge forms an autonomous component which can be inserted or withdrawn individually.

7. The low-voltage power breaker as claimed in one of the preceding claims,
characterized
in that, in order to support and accommodate the arc splitter cartridges (28, 29, 30; 41, 42), the partitions (15, 16; 32) have support elements and holders for the isolating walls (22, 23, 24, 25, 26, 27) of the arc splitter cartridges (28, 29, 30; 41, 42).

8. The low-voltage power breaker as claimed in one of the preceding claims,
characterized
in that, in order to retain the arc splitter cartridges (28, 29, 30; 41, 42) in the entire arc-quenching area (9; 14; 31), one arcing chamber cover (43, 44, 45) is provided per switching pole (6, 7, 8).

9. The low-voltage power breaker as claimed in one of the preceding claims,
characterized
in that arc guide horns (11) are provided on the fixed terminal bar of the low-voltage power breaker.

10. The low-voltage power breaker as claimed in claim 9,
characterized
in that one arc guide horn (11) is arranged on the fixed terminal bar for each quenching device element.
